(19) United States
(12) Patent Application Publication
(10) Pub. No.: US 2026/0187160 A1
(43) Pub. Date: Jul. 2, 2026

(54) AUTOMATIC FOLDER CATEGORIZATION OF DOCUMENTS BASED ON EMBEDDED BRAND LOGO ELEMENTS

(71) Applicant: Kyocera Document Solutions Inc., Osaka (JP)

(72) Inventor: Selim Zaman, San Mateo, CA (US)

(73) Assignee: Kyocera Document Solutions Inc., Osaka (JP)

(21) Appl. No.: 19/454,585

(22) Filed: Jan. 21, 2026

Related U.S. Application Data
(63) Continuation-in-part of application No. 18/929,084, filed on Oct. 28, 2024.

(51) Int. Cl. G06F 16/93; G06F 21/62

(52) U.S. Cl. CPC G06F 16/93; G06F 21/6209

(57) ABSTRACT

The claimed invention relates to management of documents with branding. The system receives at least one document and detects at least one logo. The system retrieves branding information based on the detected logos and generates folders based on the branding information and a preset threshold. The system then verifies access rights to the at least one document and modifies a location of documents based on the branding information and the preset threshold.

### RELATED APPLICATIONS

The present application is a continuation-in-part of U.S. patent application Ser. No. 18/929,084, filed Oct. 28, 2024, which is incorporated by reference herein in its entirety.

### FIELD

The present disclosure relates to automatically categorizing documents based on embedded brand logo reflecting document origin. More particularly, the present disclosure relates to categorizing documents by metadata of documents for initial categorization and by detected brand logos for further document categorization and storing documents in subfolders.

### BACKGROUND

A document management system may import documents in bulk into the document management system. After importing documents, users manually organize their folder structures, such as creating company-specific folders and placing relevant documents therein.

When a large number of documents are uploaded to the document management system, downstream processing of the documents becomes cumbersome or error-prone due to variety of brand logos or brand companies between the various documents. Further, slight variations of brand logos may cause confusion to the user while categorizing the documents manually to the document management system. While categorizing documents to a designated folder, the folder may not have enough capacity to save the document and may cause confusion to the user in categorizing the documents manually to the document management system.

### SUMMARY

In one embodiment, the present disclosure is directed to a method for modifying an electronic document management structure. The method includes updating a look-up table, wherein the look-up table includes branding information, and retrieving a plurality of documents in a server. The method further includes detecting at least one brand logo in at least one document of the plurality of documents, extracting corresponding branding information from the look-up table based on the at least one detected brand logo, determining a file count of a folder containing the at least one document, verifying access rights to the at least one document and access rights to the at least one subfolder based on the corresponding branding information, generating, based on the file count, at least one subfolder associated with each of the at least one branding information, and modifying a file location of the at least one document to be the at least one subfolder.

In another embodiment, the present disclosure is directed to a method for modifying an electronic document management structure. The method includes updating at least one look-up table, wherein the look-up table includes branding information, and detecting a brand logo in at least one document of a plurality of documents, wherein the at least one document is stored in a subfolder. The method further includes extracting corresponding branding information from the look-up table based on the brand logo, determining a file count of a folder containing the at least one document, verifying access rights to the at least one document based on the corresponding branding information, modifying, based on the file count and the verified access rights, a location of the at least one document to a folder associated with the corresponding branding information, and deleting the subfolder.

In a further embodiment, the present disclosure is directed to a system for modifying an electronic document management structure. The system includes a server including a monitoring engine, a detection engine, a rights management module, a folder management module, and a look-up table. The look-up table includes branding information associated with at least one brand logo. The monitoring engine is operable to detect a modification of the lookup table. The detection engine is operable to detect the at least one brand logo in at least one document of the plurality of documents and extract corresponding branding information from the look-up table based on the at least one detected brand logo. The folder management module is operable to determine a file count of a folder containing the at least one document, modify, based on the file count a location of the at least one document to a folder associated with the corresponding branding information, and delete the subfolder. The rights management module is operable to verify access rights to the at least one document based on the corresponding branding information.

The method may include modifying document-class access rights and/or folder-class access rights to maintain access to the at least one document. The method may include determining a mismatch between the access rights to the folder containing the at least one document and the at least one subfolder. The method may include sending an access rights modification request to an account associated with a manager role prior to the generating the at least one subfolder. The method may include detecting a loss of rights for a user account based on the updating of the look-up table and generating an alert for the user account based on the loss of rights.

The method may further include determining, based on the corresponding branding information, the folder associated with the corresponding branding information is a close-match subfolder for the at least one document. The method may further include determining a mismatch between access rights to the close-match subfolder and the access rights to the at least one document. The method may further include receiving approval from at least one user account and modifying the access rights to the at least one document. The method may further include determining a mismatch between the access rights to the at least one document and access rights to the folder associated with the corresponding branding information. The method may further include generating a prompt based on the updating of the lookup table, and sending an access rights modification request to an account associated with a manager role. The method may further include detecting a loss of rights for a user account and generating a prompt for the user account based on the loss of rights.

The system may further include a folder management module operable to determine a close-match subfolder for the at least one document based on the corresponding branding information. The system may further include a rights management module operable to determine a mismatch between access rights to the close-match subfolder and the access rights to the at least one document. The system may further include a rights management module operable to modify the access rights to the at least one subfolder based on the access rights to the at least one document. The system may further include a rights management module operable to modify document-class access rights and/or folder-class access rights to maintain access to the at least one document. The system may further include a monitoring engine operable to generate a prompt based on the updating of the lookup table, wherein the prompt includes an access rights modification request. The system may further include a monitoring engine operable to detect a loss of rights for a user account based on the updating of the look-up table and generate a prompt for the user account based on the loss of rights. The system may further include a rights management module is operable to verify the access rights to the at least one document based on metadata of the at least one document.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps may be rearranged, combined, distributed, eliminated, or otherwise changed, while remaining with the scope of the disclosed embodiments.

### BRIEF DESCRIPTION OF THE DRAWINGS

Various other features and attendant advantages of the present disclosure will be more fully appreciated when considered in conjunction with the accompanying drawings.

FIG. 1 illustrates a block diagram of a document management system according to the disclosed embodiments.

FIG. 2 illustrates an OCR device according to the disclosed embodiments.

FIG. 3 illustrates a block diagram of data flow of an automatically categorizing a document to a folder when a plurality of brand logos in a document of a plurality of documents according to the disclosed embodiments.

FIG. 4 illustrates a flowchart for the end-to-end system workflow for an automatically categorizing a document with at least one brand logo to a folder according to the disclosed embodiments.

FIG. 5 illustrates a flowchart for the end-to-end system workflow for an automatically categorizing a document with multiple brand logos to a folder according to the disclosed embodiments.

FIG. 6 illustrates a flowchart for the end-to-end system workflow for redesigning data size of a document for storage in a document management system according to the disclosed embodiments.

FIG. 7 illustrates a flowchart for a folder management method based on branding information in a look-up table according to the disclosed embodiments.

FIG. 8 illustrates a system for folder management of documents with multiple subfolders based on branding information according to the disclosed embodiments.

FIG. 9 illustrates a system for folder management of documents stored in a subfolder based on branding information according to the disclosed embodiments.

FIG. 10 illustrates a system for folder management of documents stored in multiple subfolders based on branding information according to the disclosed embodiments.

FIG. 11 illustrates a flowchart of an alert method for folder management operations according to the disclosed embodiments.

FIG. 12 illustrates a system for matching a document to a closest-matched folder according to the disclosed embodiments.

### DETAILED DESCRIPTION

Reference will now be made in detail to specific embodiments. Examples of these embodiments are illustrated in the accompanying drawings. Numerous specific details are set forth in order to provide a thorough understanding. While the embodiments will be described in conjunction with the drawings, it will be understood that the following description is not intended to limit the disclosure to any one embodiment. On the contrary, the following description is intended to cover alternatives, modifications, and equivalents as may be included within the spirit and scope of the appended claims.

The disclosed embodiments provide a mechanism to efficiently categorize documents in a cloud storage of the document management system, such as during bulk import when a new user is migrating from. The disclosed embodiments also provide a method of removing a brand logo within a document to reduce the data size to create additional capacity in the destination folder.

New users of document management system often have to import documents in bulk into the system. After importing documents, the users have to manually organize their folder structures. The disclosed embodiments add a mechanism to further categorize documents within a folder based on brand logo. For a large folder, this feature automates the process the user would have to otherwise perform manually to create company specific folders and place relevant documents therein. The disclosed embodiments save few seconds of manual process during a document upload. The time saved scales up during bulk upload 100 documents which provides a business value proposition for document management system.

When bulk documents are uploaded to the document management system, each document has assigned metadata including a document class information, such as invoices, address lists, price lists or another types of document class. The document management system also has a brand logo lookup table to find brand logo information of a corresponding brand logo. The look up table contains the pre-recorded brand logo list for document categorization including brand logos and brand logo information such as corresponding company name, business name, entity name and brand name. The document class of metadata of documents are used for initial categorization into folders. Then, the brand logo information is used for categorization into sub-folders. The system can be modified for revamping existing folder structures as well.

The disclosed embodiments help organize folders by categorizing documents according to their origin as determined by brand logo. The document management system detects if a document has one or more embedded brand logos. The disclosed embodiments can also compare the detected plurality of brand logos and a brand logo lookup table to find a brand logo information of each brand logo of the plurality of brand logos. If multiple brands exist in a document, create a sub-folder for each. The system automatically repeats brand detection and the folder allocation process per document during bulk upload to save time compared with the user's manual categorization. Also, the system prompts users for assistance with any ambiguity during brand detection and folder creation. Utilization of brand logo detection technology to categorize documents to aid to access documents in large folders.

The disclosed embodiment can also create a new folder or find existing folder that corresponds to the brand logo information for the frequently occurring brand logo in the documents. If multiple logos appear the same number of times, create a folder or find existing folder for each company name and place a copy of the document in each folder.

The disclosed embodiment can also count the number of appearances of the logo and determine the logo with the most appearances and create a subfolder for the logo by looking up in the look up table when a plurality of brand logos are detected in a document.

The disclosed embodiments can also be used to update existing folders once they exceed the threshold of the destination folder. The document management system checks the destination folder size. If the documents to be saved have a larger size above a configurable threshold, then the system create sub-folders for each brand if not already existing. If an existing sub-folder size goes below than a configurable threshold due to deletions or manual movements, then the disclosed embodiments remove sub-folders putting documents back into parent folder.

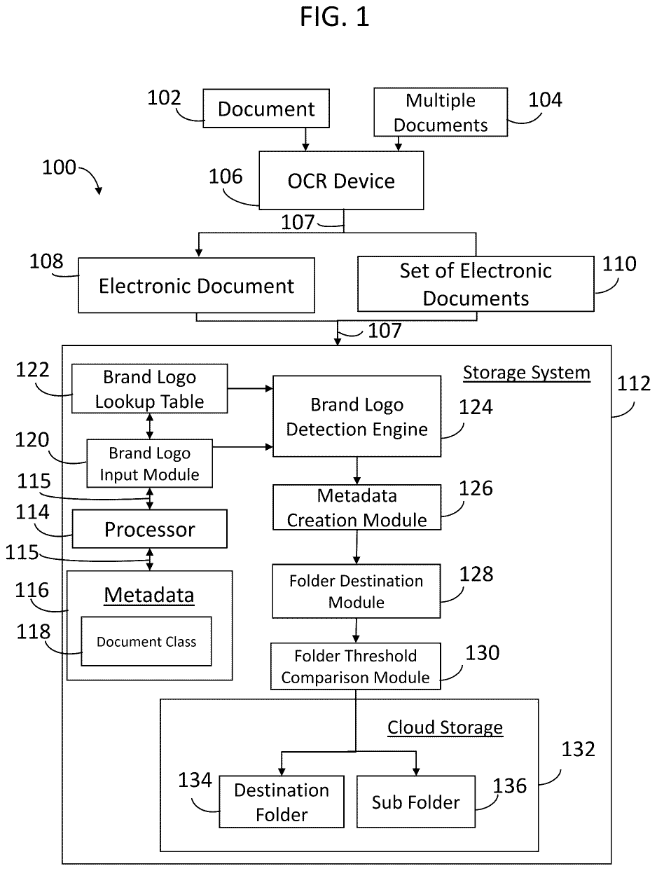

FIG. 1 depicts a block diagram of a document management system 100 according to the disclosed embodiments. Document management 100 may receive large batches of documents, processing them, and manage their access and use in operations. As part of this, document management system 100 uses a storage system 112 that stores documents that have been received and processed within system 100. One feature of the processing may be scanning or importing batches of documents by optical character recognition (OCR) device 106.

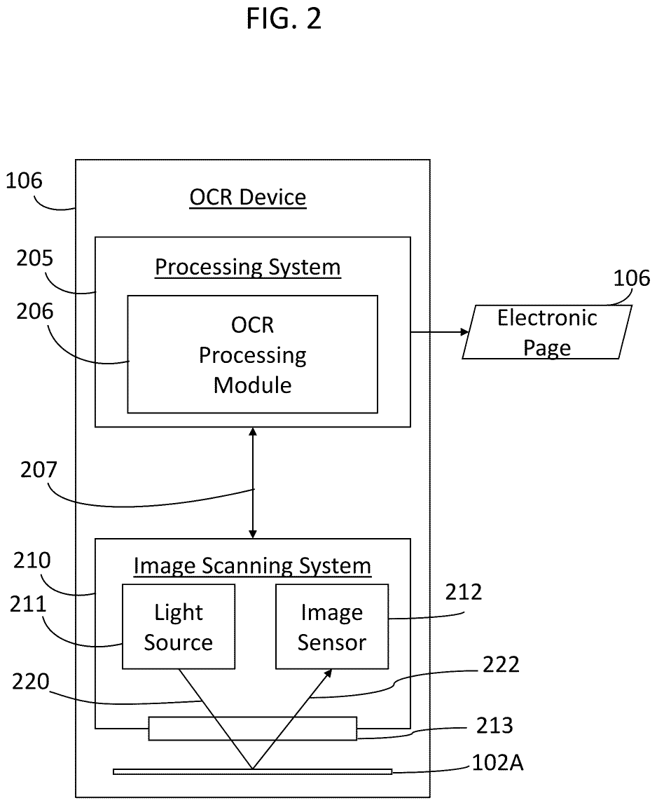

OCR device 106 is communicatively coupled to storage system 112 within system 100. OCR device 106 may be connected to storage system 112 over a network 107. OCR device 106 may be within a printing device, a scanner, a computing device, a Web Client and the like. OCR device 106 is disclosed in greater detail below by FIG. 2. Within system 100, OCR device 106 helps with the importation of large batches of documents, such as records, books/texts, forms, or other data that is in a document that is captured electronically to be managed using storage system 112.

For example, document 102 may be commercial record dating back to 1984. Many of these records are on paper and with different logos. OCR device 106 captures images of the records to generate electronic documents 108. An electronic document 108 is the electronic or image version of document 102. Electronic document 108 may include images having pixels to represent the characters and graphics within first set of documents 102. OCR device 106 imports the document 102 into system 100 by processing them.

Using the above example, multiple documents 104 also may be imported into system 100 using OCR device 106. Multiple documents 104 may be company records kept on paper for the past several years. These records also may include different formats and even different languages. OCR device 106 captures multiple documents 104 to generate a set of electronic documents 110. Set of electronic documents 110 also may include images having pixels that represent the characters and graphics within multiple documents 104.

Document 102 and multiple documents 104 include logo fields wherein logos are provided for the document itself or some text or graphic within the documents. The logo fields are not necessarily in the same place within each document. Further, the format used for the logo field may vary. The characters used in the logo fields may also be different in color or size.

Document 102 is provided to storage system 112. Storage system 112 performs pre-processing of the documents before storing them within a document module. Storage system 112, however, includes a processor 114 that executes instructions to configure the storage system to perform specified functions. Processor 114 is connected to metadata storage 116 by data bus 115. Metadata storage 116 includes document class information, such as invoices, address lists, price lists or another types of document class 118. Document class 118 may be a code that, when read by processor 114, configures storage system 112 to perform the operations disclosed herein.

Processor 114 also may be coupled to brand logo input module 120 for storage system 112. Electronic documents may be imported from OCR device 106 at brand logo input module 120 over network 107. In some embodiments, storage system 112 and OCR device 106 may be in the same device such that network 107 and brand logo input module 120 are not used. Upon receipt of the electronic documents, processor 114 executes document class 118 to configure storage system 112 to perform the pre-processing operations.

These operations may include processing an electronic document, such as electronic document 108, using a brand logo lookup table 122. Brand logo lookup table 122 analyzes one or more logos within electronic document 108 to determine if the logo on a document match with pre-recorded logo information. Brand logo detection engine 124 identifies the portion of the document and indicates that it is a possible logo. The identified fields may be highlighted or identified within the electronic documents of electronic document 108.

Electronic document 108 is analyzed by brand logo detection engine 124 after importation into storage system 112. In some embodiments, brand logo detection engine 124 may receive electronic document 108 after they have been reviewed and processed by brand logo lookup table 122. Brand logo detection engine 124 detects one or more logo within one or more documents of electronic document 108. Not every document will have a logo. Further, brand logo detection engine 124 determines a format for the logo within the logo field, as shown in the examples above.

Metadata creation module 126 receives electronic document 108 after the logo fields having logos are identified. Metadata creation module 126 determines whether the logos in each logo field matches brand logo lookup table 122. This table may be specified by a user, an administrator, company or organizational policy, and the like. Metadata creation module 126 adjusts or modifies the metadata within the logo field if they do not match the pre-set metadata. Based on document category in the metadata of the document, folder destination module 128 organizes the document and determines the destination folder. Folder threshold comparison module detects whether the destination folder 134 has sufficient capacity to save documents.

This adjustment results in a modified electronic document and an original electronic document within storage system 112. Both sets of electronic documents are stored within storage system 112. Thus, electronic document 108, as well as any modified electronic versions of the document resulting in adjusted metadata, are stored at a document module, or storage. Storage system 112 may include destination folder 134, and one or more sub folders. Destination folder 134 may store the processed and modified versions of electronic document 108 and modified version of set of electronic documents 110. Sub folder 136 may store the processed and modified versions of electronic document 108 and modified version of set of electronic documents 110 depending on the capacity of destination folder 134 and a threshold of the capacity. Each folder may include its own rules and management functions for the corresponding documents. Both folders are stored in cloud storage 132 of storage system 112.

FIG. 2 depicts OCR device 106 according to the disclosed embodiments. OCR device 106 receives a page or document 102A of document 102. Further pages may be loaded after processing of page 102A is complete. OCR device 106 includes an image scanning system 210 communicatively coupled to a processing system 205 via a communications link 207. Communications link 207 may be a wire, a communications cable, a wireless link, or a metal track on a printed circuit board.

Image scanning system 210 includes a light source 211 that projects light 220 through a transparent window 213 to strike a surface of page 102A. Page 102A, which may be a sheet of paper containing text or graphics, reflects light 220 towards an image sensor 212. Image sensor 212 contains light sensing elements, such as photodiodes or photocells, converts received light 222 into electrical signals that are transmitted to OCR processing module 206 within processing system 205. The electrical signals may be digital bits.

Processing system 205 generates electronic page 108A from the captured data for page 102A. Electronic page 108A is included in one of the electronic documents within electronic document 108. In some embodiments, OCR device 106 is a slot scanner incorporating a linear array of photocells. OCR processing module 206 that is a part of processing system 205 may be used to operate upon the electrical signals for performing optical character recognition of text and graphics printed on page 102A.

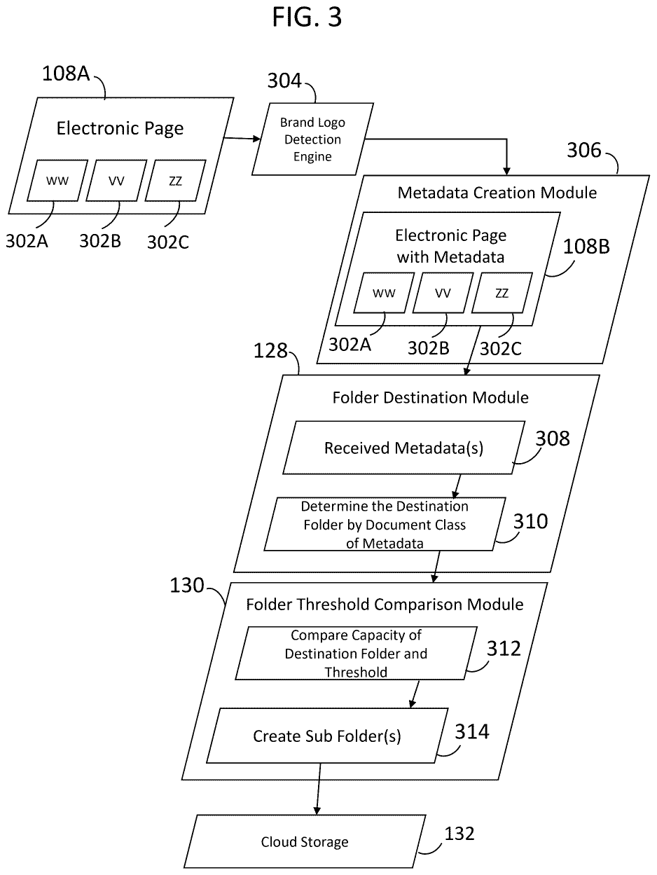

FIG. 3 depicts a block diagram of data flow of an imported original electronic page 108A of an electronic document within folder destination module 128 according to the disclosed embodiments.

Electronic page 108A is received by brand logo detection engine 304 and metadata creation module 306. Metadata creation module 306 adds the brand logo information to a document metadata 116 of the original electronic page 108A and creates electronic page with metadata 108B. Folder destination module 128 receive electronic page 108A with metadata 108B from metadata creation module 306.

Original electronic page 108 include logo field 302A, 302B, and 302C. These may be images and data characters in the electronic page that include company name, brand name, symbol or any combination thereof. For example, logo field 302A may include company name WW, logo field 302B may include brand name VV, and logo field 302C may include symbol ZZ. Of these, company name WW and brand name VV are characters while symbol ZZ are in an image format. Original electronic page 108A is updated to include metadata 116 with document class 118.

After the determination of the destination folder by the document class 118, folder threshold comparison module 130 receives electronic page with metadata 108B. Folder threshold comparison module 130 may be trained to compare the capacity of destination folder 312 and the threshold of the capacity of destination folder. Folder threshold comparison module 130 determines whether the destination folder has sufficient capacity to store electronic page with metadata 108B. When the document size is larger than the threshold, folder threshold comparison module 130 creates sub folder 314. When the document size is smaller than the threshold, folder threshold comparison module 130 will not create sub folder 314. Folder threshold comparison module 130 determines the folder to store electronic page with metadata 108B and store document in cloud storage 132. For example, when the destination folder has 1 TB storage capacity and already 900 GB has been used and the threshold of the capacity is 1000 GB. When a document user wants to store is less than 100 GB, the document is saved in the destination folder. If the document user wants to store is larger than 100 GB, thrashed comparison module 130 creates a subfolder and store the document in the subfolder.

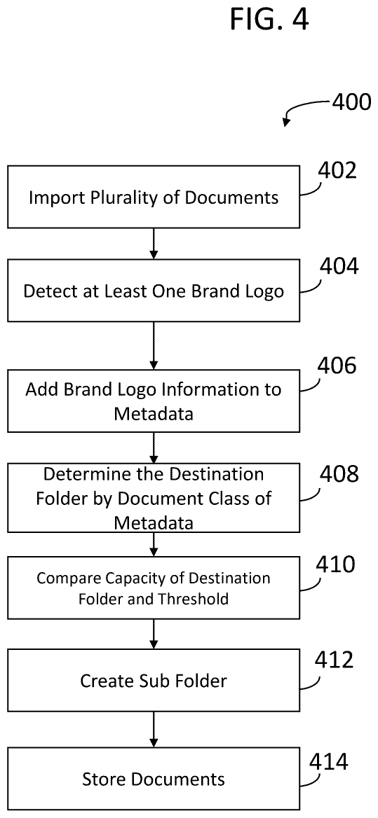

FIG. 4 depicts a flowchart 400 for automatically formatting a date field within a document according to the disclosed embodiments. Flowchart 400 may refer to FIGS. 1-3 for illustrative purposes. Flowchart 400, however, is not limited by the embodiments disclosed by FIGS. 1-3.

Step 402 executes by importing a plurality of documents into storage system 112 using OCR device 106. For example, document 102 may be scanned by OCR device 106 to generate first set of electronic documents 108. A plurality of documents may be scanned to import a large set of documents, such as 100s or 1000s of documents at once.

Step 404 executes by detecting one brand logo within one or more electronic documents of document 108. For example, each page of each document may be analyzed by brand logo detection engine 124, to identify a logo within one or more pages of the document.

Step 406 executes by comparing the brand logo and the look up table within the original electronic document 108. For example, brand logo detection engine 124 may finding the brand logo information, and adding it to the metadata. Step 408 executes by comparing received document class of the metadata to find destination folder 134 for the imported documents. For example, destination folder 134 may be the pre-created within the cloud storage 132 and set by the user, the administrator of the imported documents, and the like.

Step 410 executes by determining whether capacity of destination folder 134 is larger than threshold of destination folder for saving electronic document 108A. For example, if step 410 is larger, then step 412 executes by creating sub folder 136 under destination folder 134. If step 410 is no, then step 414 executes by storing document in destination folder.

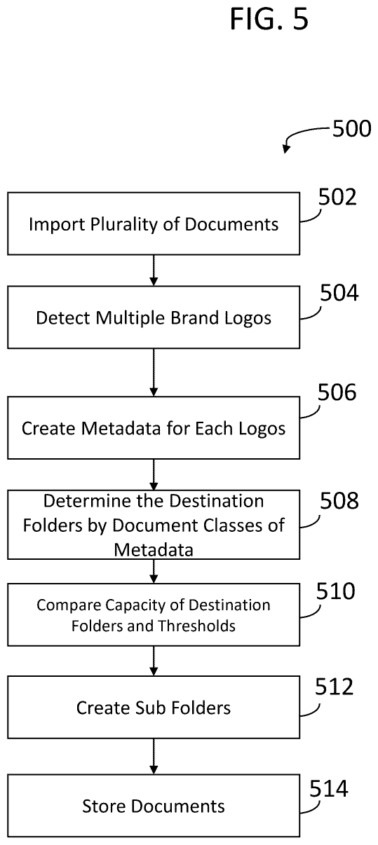

FIG. 5 depicts a flowchart 500 for automatically formatting a date field within a document according to the disclosed embodiments. Flowchart 500 may refer to FIGS. 1-4 for illustrative purposes. Flowchart 500, however, is not limited by the embodiments disclosed by FIGS. 1-4.

Step 502 executes by importing a plurality of documents into storage system 112 using OCR device 106. For example, document 102 may be scanned by OCR device 106 to generate first set of electronic documents 108. A plurality of documents may be done at once to import a large set of documents, such as 100s or 1000s of documents at once.

Step 504 executes by detecting multiple brand logos within one or more electronic documents of document 108. For example, each page of each document may be analyzed by brand logo detection engine 124, to identify logos within one or more pages of the document.

Step 506 executes by creating metadata for each logo within the original electronic document 108. For example, brand logo detection engine 124 may determine what format is being used within the identified logos. Step 508 executes by comparing received metadata to find destination folder 134 for the imported documents. Destination folder 134 may be the pre-created within the cloud storage 132 and set by the user, the administrator of the imported documents, and the like.

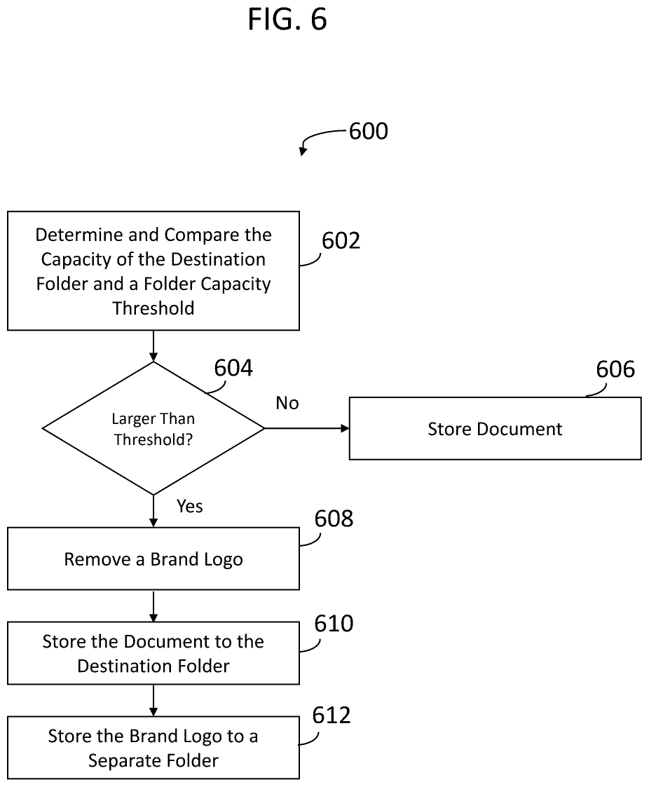

Step 510 executes by determining whether capacity of destination folder 134 is larger than threshold of destination folder for saving electronic document 108A. For example, if step 510 is larger, then step 512 executes by creating sub folders for each logo 136 under destination folders 134. If step 510 is no, then step 514 executes by storing document in destination folders. FIG. 6 depicts a flowchart 600 for automatically formatting a date field within a

document according to the disclosed embodiments. Flowchart 600 may refer to FIGS. 1-5 for illustrative purposes. Flowchart 600, however, is not limited by the embodiments disclosed by FIGS. 1-5.

Step 602 executes by determining a capacity of a destination folder 134 and comparing the capacity of the destination folder 134 and a folder capacity threshold. For example, folder threshold comparison module 130 determines whether the destination folder has sufficient capacity to store electronic page with metadata 108B. When the document size is smaller than the threshold, folder threshold comparison module 130 will not create sub folder 314. Folder threshold comparison module 130 determines the folder to store electronic page with metadata 108B and store document in cloud storage 132.

Step 604 executes by determining whether capacity of destination folder 134 is larger than threshold of destination folder for saving electronic document 108A. If step 604 is no, then step 606 executes by storing document in destination folders. For example, when the document size is smaller than the threshold, folder threshold comparison module 130 will not create sub folder 314.

If step 604 is yes, then step 608 executes by removing a logo to reduce document size of the electronic document 108A. Step 610 executes by storing the document to the destination folder. Step 612 executes by storing the brand logo to a separate folder. For example, when the document size is larger than the threshold, removing a logo of the document and storing the document in the destination folder and the removed logo is stored to a separate folder.

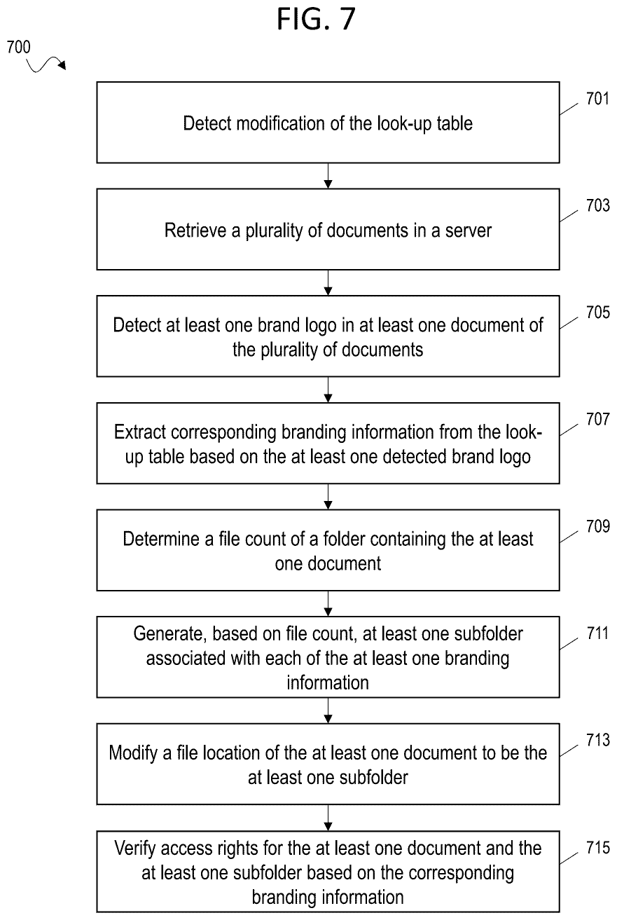

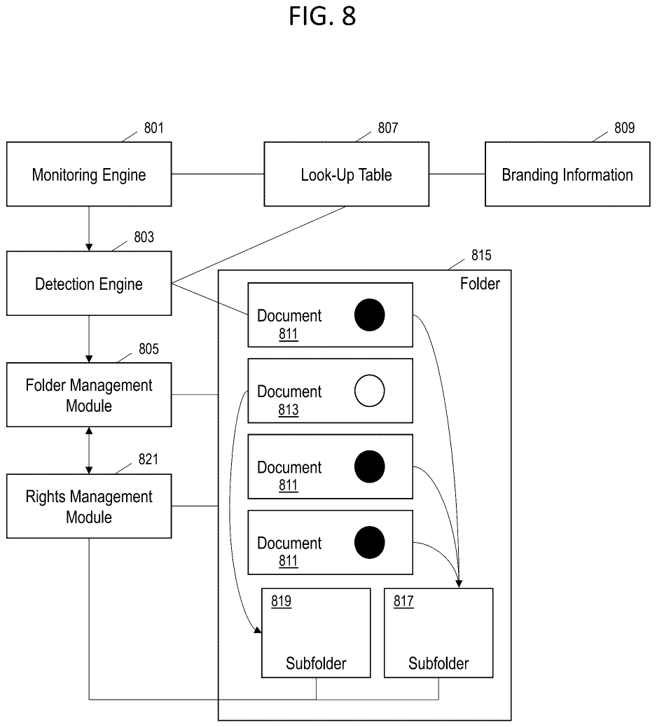

FIG. 7 illustrates a flowchart 700 according to the disclosed embodiments wherein modification of the look-up table 807 results in recategorization of documents. Flowchart 700 may refer to FIGS. 8-10 and 12 for illustrative purposes. Flowchart 700, however, is not limited by the embodiments disclosed by FIGS. 8-10. Step 701 executes by detecting a modification of the look-up table 807. The detection is preferably performed by a detection engine 803. The modification is, in one embodiment, a modification from a user manually updating the look-up table 807. In another embodiment, the look-up table 807 is automatically updated based on an upload or other input from a user. The updating of the look-up table 807 includes adding or removing a brand logo to the look-up table 807 and/or adding or removing branding information associated with a brand logo to the look-up table 807.

It may be appreciated that the brand logo is a graphic, image, or other electronic file that is readable by a computer or device. In other words, the data to support the generation of the brand logo is comprised of data that is processed, such as through OCR, and stored in an electronic file format. Look-up table 807 may include these data files for the one or more brand logos. An update of the brand logo may include removing, adding, or modifying such data within the electronic file associated with the respective brand logo.

Step 703 executes by retrieving a plurality of documents in a server 703. The documents are, in one embodiment, uploaded to a server, and the system performs the electronic file management operations at the same time as OCR processes. In another embodiment, the system performs the folder management operations independently of OCR processes and electronic file uploads. The system then detects at least one brand logo in at least one document of the plurality of documents 705. The detection occurs via any of the detection processes described herein.

In one embodiment, the detection identifies at least one brand logo across a plurality of documents. In another embodiment, the system detects two or more logos across the plurality of documents based on the counts of the electronic data related to the one or more logos detected within the system. The system then calculates an occurrence count for documents containing each of the logos. If the count of documents containing first logo is above a preset threshold and/or if the count of the first logo is greater than the counts of documents other logos, then the system is operable to perform the folder management operations based on the first logo rather than the other logos. For example, if a set of documents includes 50 occurrences of electronic files with a first logo and 20 occurrences of electronic files with a second logo, the system is operable to determine there are more occurrences of documents with the first logo and perform the folder management operations based on the 50 documents with the first logo rather than the 20 documents with the second logo.

In another embodiment, the system is operable to extract corresponding branding information from the look-up table 807 based on the at least one detected brand logo 707. Branding information includes, in one embodiment, a corresponding company name, business name, entity name and brand name. The look-up is performed, in one embodiment, by the detection engine 803, wherein the detection engine 803 is operable to both detect logos in documents and retrieve information from the look-up table 807 based on the detected logo.

Step 709 executes by determining an electronic file occurrence count of a folder containing the at least one document. Because folder hierarchies as disclosed are typically built for use by an end-user (i.e., a user browses the folder hierarchy for finding, viewing, and retrieving relevant documents), the system is operable to manage folders based on a number of documents associated with a particular logo, wherein folders contain a preset number of electronic files. This permits each folder to contain a manageable and browsable number of documents sufficient for managing documents associated with a particular logo or branding information. For example, the system is operable to count a number of documents with a particular logo in a folder and compare the count to a preset threshold. If the threshold is set to 100 documents and the count of documents with the logo is 115, the system is operable to perform the folder modification process to generate subfolders and modify electronic file locations such that each folder has less than or equal to the preset threshold of electronic files.

Step 711 executes by generating at least one subfolder, wherein the subfolder is associated with each of the at least one branding information. For example, if the branding information includes information related to a subsidiary of a company associated with the logo, the system is operable to create subfolders for documents containing the subsidiary logos. In one embodiment, if a folder contains 115 documents, wherein a first set of documents include logos XXX and YYY, and a second set of documents include logos XXX and ZZZ, the system is operable to retrieve branding information from the look-up table 807 identifying YYY and ZZZ as subsidiaries of XXX. Then, the system is operable to generate a subfolder based on the subsidiary information for the first set of documents and/or the second set of documents prior to modifying electronic file locations.

Step 713 executes by modifying an electronic file location of at least one document to be at least one subfolder. In the example illustrated above, the system is operable to modify an electronic file location of the first set of documents containing XXX and YYY logos to a subfolder and/or modify a location of the second set of documents containing XXX and ZZZ logos. In one embodiment, the system generates a first subfolder for the documents containing XXX and YYY logos and generates a second subfolder for the documents containing XXX and ZZZ logos. In a further embodiment, the system generates a subfolder and modifies an electronic file location based on electronic file occurrence counts. For example, if a folder includes 115 documents each with at least one XXX logo, the system is operable to modify an electronic file location of 15 documents to a subfolder such that each folder or subfolder contains less than or equal to the threshold number of electronic files.

In one embodiment, the system generates folders for each of the logos, XXX, YYY, and ZZZ, and copies a document containing one or more of the logos to each of the corresponding folders such that one copy of the document exists in each folder. In another embodiment, the system modifies a location of the documents based on the most predominant logo in a document (i.e., the logo with the highest occurrence count). In a further embodiment, if a count of the logos in each document are equal, then the system copies the electronic file into a corresponding folder for each of the logos such that a copy of the document exists in each folder.

Step 715 executes by verifying access rights for at least one document and at least one subfolder based on the corresponding branding information. In one embodiment, access rights are managed via dual-class security rights. In order to access a document, a user account must have both document-class rights and folder-class rights. User accounts are divided between general users and manager users. If a general user has folder-class rights, then having document-class rights provides access to the document, but having no document-class rights prevents access to the document. If a general user has no folder-class rights then the general user has no access, whether or not it has document-class rights. If a manager user has folder-class rights, then having document-class rights provides access to the document, but having no document-class rights prevents access to the document. If a manager user does not have folder-class rights but does have document-class rights, then it may access the document. If a manager has neither folder-class rights nor document-class rights, then it does not have access to the document. In one embodiment, a manager user without folder-class rights but with document-class rights is only permitted to access the document via a search function. The rights management is further summarized in the following table:

TABLE 1
Access Rights

| | | General User | Manager User |
|---|---|---|---|
| Folder-Class | Document Class | Accessible | Accessible |
| Rights | Rights | | |
| | No Document Class | No Access | No Access |
| | Rights | | |
| No Folder-Class | Document-Class | No Access | Accessible |
| rights | Rights | | |
| | No Document-Class | No Access | No Access |
| | Rights | | |

The system is operable to verify access rights for documents and folders based on a modification of an electronic file location. For example, a user account may have folder-class access to a subfolder and document-class access to a document stored in the subfolder. When the system modifies a location of the document from the subfolder to a parent folder, the user may not have folder-class access to the parent folder. Accordingly, the user would have no access to the document. The system is therefore operable to determine a modification operation would remove access for a user account based on comparing the access rights of the user account the document and the modified location. If the system determines an operation would result in a user losing access rights, the system is operable to send a prompt to at least one user account identifying the access rights that will be lost by the operation. The prompt includes an approval request, wherein upon receiving an approval via the prompt the system is operable to perform the modification of the location. In one embodiment, the prompt is sent to a user account performing the operation. In another embodiment, the system sends the prompt to a manager account, even if a general user account is performing the operation.

In another embodiment, the system is operable to verify access rights following a modification of electronic file locations, wherein the system then updates rights to maintain user account access. For example, after a document is moved from a subfolder to a parent folder, the system is operable to determine a general user account lost access rights because the general user account does not have folder-class rights to the parent folder. The system is operable to determine the corresponding document-class rights and folder-class rights of the general user account and modify the folder-class rights and/or the document class rights of the general user account to have access to the parent folder so that the general user account maintains access to the document. In a further embodiment, the system is operable to modify document-class rights for a manager account to ensure the manager account maintains access to a document once the document is moved from a subfolder that it has folder-access rights to a folder that it has no folder-access rights.

FIG. 8 illustrates a system for folder management according to the disclosed embodiments. The illustrated system highlights specific features of the folder management system but is not exclusive the structures and features previously described, illustrated, and applicable to the illustrated embodiment. In the illustrated embodiment, the system includes a monitoring engine 801, a detection engine 803, and a folder management module 805. The illustrated features are operable to perform at least the methods and functions described with reference to FIG. 7. The monitoring engine 801 is operable to access and retrieve information from a look-up table 807, wherein the look-up table 807 includes branding information 809. The look-up table 807 in one embodiment is a table including logos and information associated with the logos 809, such as a company name, business name, entity name, brand name, subsidiaries, associated entities, and/or preferences for document and folder management.

A detection engine 803 is operable to receive at least one document 811, wherein the document includes a logo. In the illustrated embodiment, three documents 811 have a first logo, and one document 813 has a second logo. The documents 811, 813 are, in one embodiment, stored in a folder 815 and accessed by the detection engine 803 from the folder. In another embodiment, the detection engine 803 receives the documents 811, 813 prior to their storage in the folder 815 or a subfolder 817. The detection engine 803 is operable to detect one or more logos in each of the documents based on the methods and processes disclosed herein. The detection engine 803 is further operable to retrieve branding information 809 from the look-up table 807 for each of the documents 811, 813 based on the detected logos. The folder management module 805 is operable to generate at least one subfolder 817 based on the branding information 809 associated with the logos of the documents 811, 813. The folder management module 805 is further operable to modify an electronic file location of each of the documents 811, 813 based on the logos and/or the branding information 809 associated with the logos. In the illustrated embodiment, the folder management module 805 determines documents 811 have a first logo. Based on the first logo and branding information associated with the first logo, the folder management module 805 generates subfolder 817 and modifies an electronic file location of the documents 811 to a subfolder 817.

The folder management module 805 is further operable to determine an occurrence count of the documents 811, 813 in the folder 815 and compare the count to a preset threshold. If the count is greater than the preset threshold, then the folder management module 805 modifies an electronic file location of one or more of the documents 811, 813 to be the subfolder 817, such that an electronic file count of the folder 815 and the subfolder 817 are below the threshold. In one embodiment, upon determining the electronic file occurrence count of the folder 815 is above a preset threshold, the folder management module 805 is operable to generate a first subfolder 817 and modify the location of documents 811 containing a first logo to be the first subfolder 817.

The system is further operable to modify electronic file locations for multiple documents into multiple subfolders 817, 819. For example, the detection engine 803 is operable to retrieve branding information 809 for a first set of documents 811 with a first logo and a second set of documents 813 with a second logo. Based on the branding information 809 and a preset threshold, the folder management module 805 is operable to generate a first subfolder 817 associated with first branding information and a second subfolder 819 associated with second branding information. The folder management module 805 is further operable to modify a location of the first set of documents 811 to the first subfolder 817 and modify a location of the second set of documents 813 to the second subfolder 819.

In a further embodiment, the system includes a rights management module 821, wherein the rights management module 821 is operable to manage rights for folders, subfolders, and documents. For example, in the illustrated embodiment, the rights management module 821 is operable to verify that moving the documents 811, 813 into subfolders 819, 817 will result in a loss of rights for at least one user account. Based on the determined loss of rights, the rights management module 821 is operable to send a prompt to at least one user account with at least one approval request and receive at least one approval or denial via the prompt. If the rights management module 821 receives an approval, the system proceeds with modifying the electronic file locations of the documents 811, 813 via the folder management module 805. If the rights management module 821 receives a denial, the system does not modify the electronic file locations.

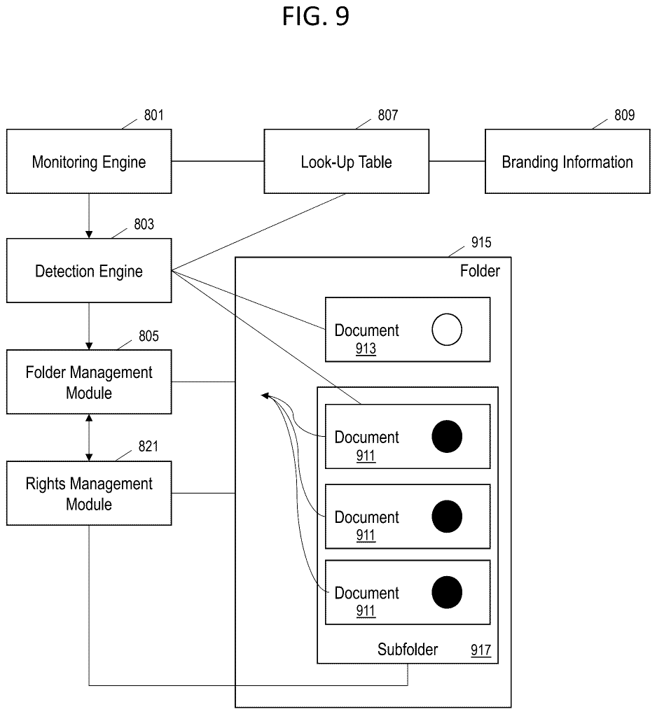

FIG. 9 illustrates another embodiment of the folder management system, wherein the folder management module 805 is operable to modify a location of documents containing a first logo 911 from the subfolder 917 to a parent folder 915. In the illustrated embodiment, the monitoring engine 801 is operable to detect an update of the look-up table 807. Based on the update, the detection engine 803 is operable to query for documents stored in a folder hierarchy, including subfolders, and determine at least one document 911 includes at least one first logo. The detection engine 803 is further operable to determine branding information 809 stored in the look-up table 807.

In one embodiment, the folder management module 805 is operable to determine an occurrence count of electronic files in the subfolder 917 and the parent folder 915 and compare the count to a predetermined threshold. If the occurrence count is equal to or less than a predefined threshold, the folder management module 805 is operable to modify a location of the documents 911 from the subfolder 917 to the parent folder 915. In one embodiment, the threshold is a preset number in the system. In another embodiment, the threshold is stored in the look-up table 807. The folder management module 805 is operable to modify a location of the documents 911, 913 based on the branding information 809 in the look-up table 807. In a further embodiment, the subfolder 917 includes additional electronic files, wherein the additional electronic files are either moved to the parent folder 915 or deleted.

A rights management module 821 is operable to verify and determine a loss of rights based on the electronic file management operations. The rights management module 821 is operable to determine moving the documents 911 from the subfolder 917 to the folder 915 would result in a loss of rights for at least one user account. For example, a general user account may have document-class access to the documents 911 and folder-class access to the subfolder 917 but not folder-class access to the parent folder 915. Thus, the rights management module 821 generates a prompt for approval of the modifying of the electronic file locations. Based on an approval, the folder management module 805 modifies the electronic file locations of the documents 811 to the parent folder 915.

The rights management module 821 is further operable to modify access rights for a document or folder after modifying a location of the document. For example, after the document is moved to a subfolder, the rights management module 821 is operable to determine a user account does not have access rights to the document due to a loss in document-class or folder-class rights. The rights management module 821 is thereby operable to modify access rights for the user account, for the document, and/or for the subfolder so that the user account has access to the document in the new location.

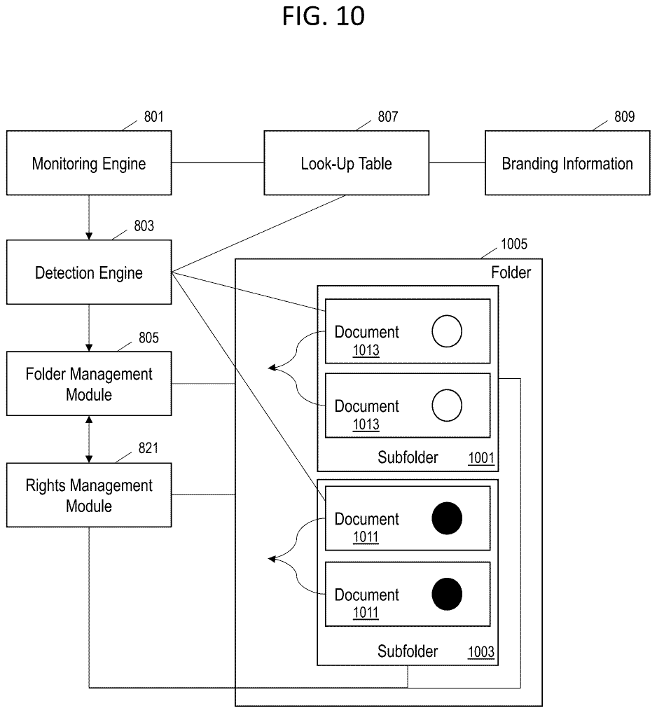

FIG. 10 illustrates one embodiment of FIG. 9 with multiple subfolders 1001, 1003. In the illustrated embodiment, the parent folder 1005 contains two subfolders 1001, 1003, wherein the first subfolder 1001 contains documents 1013 with a first logo, and wherein the second subfolder 1003 contains documents 1011 with a second logo. Based on an update of the look-up table 807, the folder management module 805 is operable to modify a location of the documents in each subfolder 1001, 1003 to the parent folder 1005. In the illustrated embodiment, the folder management module 805 deletes the subfolders 1001, 1003 after modifying the electronic file locations to the parent folder 1005. In another embodiment, the subfolders 1001, 1003 remain empty but are not deleted by the system.

In the illustrated embodiment, a rights management module 821 further determines modifying an electronic file location of the documents 1011, 1013 results in a loss of rights for at least one user account. For example, modifying the electronic file location of the documents 1011, 1013 to a parent folder 1005 would result in a loss of rights for at least one general user account and would result in additional general user accounts gaining access rights. The rights management module 821 is operable to send a prompt to at least one user account with an approval request. Based on an approval, the folder management module 805 is operable to modify the electronic file locations. In another embodiment, the rights management module 821 is operable to modify access rights for at least one user account after the documents 1011, 1013 are moved to a parent folder so that the user account maintains access to the document. In a further embodiment, the rights management module 821 generates a prompt with an approval request for modifying the document-class rights or folder-class rights for at least one user account.

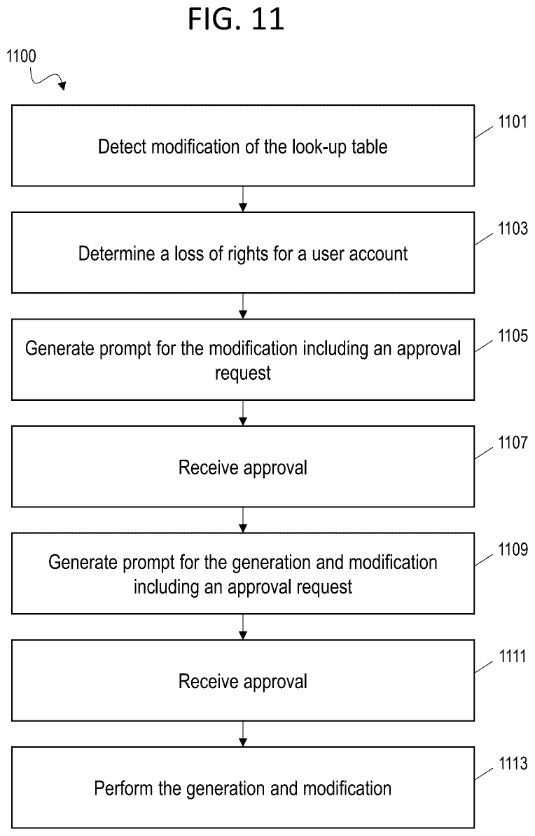

FIG. 11 illustrates a flowchart 1100 according to the disclosed embodiments wherein modification of the look-up table 807 results in recategorization of documents. Flowchart 1100 may refer to FIGS. 8-10 and 12 for illustrative purposes. Flowchart 1100, however, is not limited by the embodiments disclosed by FIGS. 8-10 and 12. Step 1101 executes by detecting an actual or proposed update to the look-up table 807. Step 1103 executes by determining a loss of rights for at least one user account. The loss of rights is determined based on detecting a mismatch between a user account's access rights for a document or folder and any document-class or folder-class rights associated with the user account and/or stored in the look-up table 807. Step 1105 executes by generating a prompt based on the loss of rights, wherein the prompt includes an approval request. In one embodiment, the system reverts a change or prevents a modification based on receiving a rejection via the prompt. In another embodiment, step 1107 executes by receiving an approval, wherein the system permits the modification to the look-up table 807 and/or begins other folder management operations.

If the system determines a modification or generation would result in a loss of rights, step 1109 executes by generating a prompt for the generation and modification according to the methods and processes described herein, wherein the prompt includes an approval request. The prompt includes an approval request, wherein the approval request is based on the proposed generation of at least one folder and modification of at least one electronic file location based on branding information. Step 1111 executes by receiving approval. After receiving approval, step 1113 executes by performing the folder management operations, including the generation and modification. In one embodiment, the alerts and prompts are generated by a monitoring engine and/or a rights management module, wherein a single monitoring engine or rights management module monitors both the look-up table 807 and folder management operations, or wherein separate monitoring engines or rights management modules monitor the look-up table 807 and folder management operations.

User accounts are, in one embodiment, associated with specific roles, such as a management role. The system is configured to provide prompts according to a user role. For example, based on a proposed generation of at least one folder and a modification of at least one electronic file location, the system is operable to provide the prompt to an account associated with a manager role, an account associated with a user role, or both accounts.

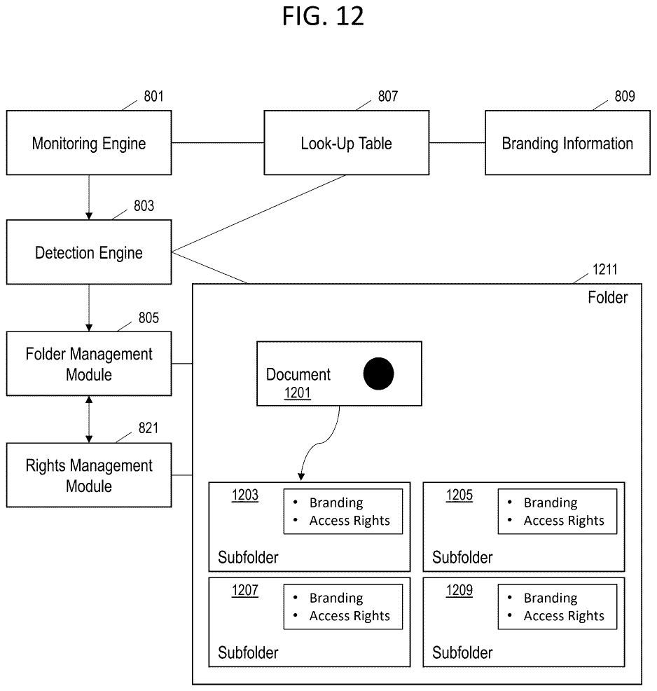

FIG. 12 illustrates one embodiment of matching a document 1201 to a closest-matched folder. In the illustrated embodiment, subfolders 1203, 1205, 1207, 1209 include metadata such as branding and access rights. The rights management module 821 is operable to obtain metadata from the subfolder, from the document being moved, documents stored in the subfolder, and/or metadata in the look-up table 807 to determine a close-match folder for the document. In one embodiment, the rights management module 821 determines a “close match” score for each of the subfolders 1203, 1205, 1207, 1209. based on the metadata. For example, in one embodiment, the rights management module 821 determines a high “close match” score based on the document 1201 and a subfolder 1203 having branding information that match. The rights management module 821 is operable to determine subfolders 1205, 1207, 1209 have branding information that does not match or does not match as many metadata attributes as the first subfolder 1203 and accordingly assign a higher “close match” score to the first subfolder 1203.

In another embodiment, the rights management module 821 is operable to determine the document 1201 relates to corresponding branding information 809 in the look-up table 807 and assign a “close match” score to a subfolder based on a comparison of the corresponding branding information 809 to metadata of the subfolders 1203, 1205, 1207, 1209 and/or documents within the subfolders 1203, 1205, 1207, 1209. Notably, the system is operable to calculate a “close match” score during any folder management operation, such as determining whether a subfolder or a parent folder is a “close match,” determining whether a first subfolder or a second subfolder is a “close match,” or determining whether a new folder or a current folder is a “close match.”

Notably, the rights management module 821 is further operable to determine a “close match” folder based on access rights. For example, in one embodiment, the document includes an “approval status” metadata attribute. In one embodiment, each folder includes an “approval” attribute, which permits or prevents non-approved documents from being moved to the folder. If a document has an “approval status” of “approved,” then the folder management module 805 is operable to modify the location of the document to a subfolder that permits approved documents. In one embodiment, the rights management module 821 performs verification prior to the folder management module 805 modifying the location of any documents. In another embodiment, the rights management module 821 performs a verification on existing subfolders containing documents to ensure no documents without “approved” status are contained in the folder.

In one embodiment, the system is operable to modify a location of a document to be a generic folder upon determining there are either no “close match” folders, based on a low “close match” score not meeting a predefined threshold, and/or based on none of the folders containing matching attributes (such as access rights, branding information, or other metadata). The folder management module 805 is operable to generate a generic folder or generic subfolder and modify a location of each of the documents to be the generic folder or generic subfolder.

In another embodiment, the system is operable to perform the folder management operations and retain an original folder structure while generating a new, parallel folder structure based on the detected branding information. In this embodiment, the system is operable to keep the original folder structure intact while generating a separate, parallel folder structure that mirrors a new structure dictated by the branding information and/or the look-up table. For example, in one embodiment, a folder hierarchy includes documents organized by patient information, such as names and cities. Based on a modification of the look-up table, the system is operable to generate a parallel folder structure containing the same files but organized by detected logo, image, or other related metadata. The detected logo, image, or other related metadata may include, for example, brain-related images, such that a user is operable to categorize and review files with unique brain images and other relevant metadata. In another embodiment, this may further enable a user to review and categorize documents related to a particular insurance company for the purpose of an insurance or financial audit. Accordingly, under this embodiment, the original folder structure remains intact, as well as the original file categorization, while a parallel structure permits use-case categorization and querying without the risk of losing any original hierarchy.

As will be appreciated by one skilled in the art, the folder management operations disclosed herein may be embodied as a system, method or computer program product. Accordingly, the folder management operations may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the folder management operations may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the folder management operations may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure references flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The present disclosure has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present disclosure covers the modifications and variations disclosed above provided that these changes come within the scope of the claims and their equivalents

What is claimed is:

1. A method for modifying an electronic document management structure, the method comprising:
updating a look-up table, wherein the look-up table includes branding information;
retrieving a plurality of documents in a server;
detecting at least one brand logo in at least one document of the plurality of documents;
extracting corresponding branding information from the look-up table based on the at least one detected brand logo;
determining a file count of a folder containing the at least one document;
verifying access rights to the at least one document and access rights to the at least one subfolder based on the corresponding branding information;
generating, based on the file count, at least one subfolder associated with each of the at least one branding information; and
modifying a file location of the at least one document to be the at least one subfolder.

2. The method of claim 1, wherein verifying the access rights further comprises modifying document-class access rights and/or folder-class access rights to maintain access to the at least one document.

3. The method of claim 1, further comprising determining a mismatch between the access rights to the folder containing the at least one document and the at least one subfolder.

4. The method of claim 1, further comprising sending an access rights modification request to an account associated with a manager role prior to the generating the at least one subfolder.

5. The method of claim 1, further comprising detecting a loss of rights for a user account based on the updating of the look-up table, and generating an alert for the user account based on the loss of rights.

6. A method for modifying an electronic document management structure, the method comprising:
updating at least one look-up table, wherein the look-up table includes branding information;
detecting a brand logo in at least one document of a plurality of documents;
wherein the at least one document is stored in a subfolder;
extracting corresponding branding information from the look-up table based on the brand logo;
determining a file count of a folder containing the at least one document;
verifying access rights to the at least one document based on the corresponding branding information;
modifying, based on the file count and the verified access rights, a location of the at least one document to a folder associated with the corresponding branding information; and
deleting the subfolder.

7. The method of claim 6, further comprising determining, based on the corresponding branding information, the folder associated with the corresponding branding information is a close-match subfolder for the at least one document.

8. The method of claim 7, further comprising determining a mismatch between access rights to the close-match subfolder and the access rights to the at least one document.

9. The method of claim 6, wherein verifying the access rights further comprises receiving approval from at least one user account and modifying the access rights to the at least one document.

10. The method of claim 6, further comprising determining a mismatch between the access rights to the at least one document and access rights to the folder associated with the corresponding branding information.

11. The method of claim 6, further comprising generating a prompt based on the updating of the lookup table, and sending an access rights modification request to an account associated with a manager role.

12. The method of claim 6, further comprising detecting a loss of rights for a user account and generating a prompt for the user account based on the loss of rights.

13. A system for modifying an electronic document management structure, the system comprising:
a server including:
a monitoring engine;
a detection engine;
a rights management module;
a folder management module; and
a look-up table;
wherein the look-up table includes branding information associated with at least one brand logo;
wherein the monitoring engine is operable to detect a modification of the lookup table;
wherein the detection engine is operable to:
detect the at least one brand logo in at least one document of the plurality of documents; and
extract corresponding branding information from the look-up table based on the at least one detected brand logo; and
wherein the folder management module is operable to:
determine a file count of a folder containing the at least one document;
modify, based on the file count a location of the at least one document to a folder associated with the corresponding branding information; and
delete the subfolder;
wherein the rights management module is operable to:
verify access rights to the at least one document based on the corresponding branding information.

14. The system of claim 13, wherein the folder management module is operable to determine a close-match subfolder for the at least one document based on the corresponding branding information.

15. The system of claim 14, wherein the rights management module is further operable to determine a mismatch between access rights to the close-match subfolder and the access rights to the at least one document.

16. The system of claim 13, wherein the rights management module is further operable to modify the access rights to the at least one subfolder based on the access rights to the at least one document.

17. The system of claim 13, wherein the rights management module is further operable to modify document-class access rights and/or folder-class access rights to maintain access to the at least one document.

18. The system of claim 13, wherein the monitoring engine is operable to generate a prompt based on the updating of the lookup table, wherein the prompt includes an access rights modification request.

19. The system of claim 13, wherein the monitoring engine is operable to detect a loss of rights for a user account based on the updating of the look-up table and generate a prompt for the user account based on the loss of rights.

20. The system of claim 13, wherein the rights management module is further operable to verify the access rights to the at least one document based on metadata of the at least one document.
